(19) United States
(12) Patent Application Publication
(10) Pub. No.: US 2026/0267699 A1
(43) Pub. Date: Sep. 10, 2026

(54) SERVER FOR RESOURCE MOVEMENT MODELING WITH ENHANCED ACCURACY AND LATENCY

(71) Applicant: Stripe, Inc., South San Francisco, CA (US)

(72) Inventors: Yue DUAN, Allen, TX (US); Bo XU, Dublin, CA (US)

(21) Appl. No.: 19/074,255

(22) Filed: Mar. 7, 2025

(51) Int. Cl. G06F 9/50

(52) U.S. Cl. CPC G06F 9/5027

(57) ABSTRACT

A server computing system is configured to perform operations comprising handling a request associated with a resource, detecting a first resource movement and a second resource movement associated with receiving the resource from a user, and generating a graph associated with a speed of receiving the resource, based on the first resource movement and the second resource movement. The server selects one of a plurality of models, based on the graph, the selected model comprising an association between a first amount of the resource at a first time and a second amount of the resource at a second time that is after the first time. The server determines a condition associated with the resource based on the model and a current amount of the resource, and responds to the request with the condition associated with the resource.

### BACKGROUND

Server computing systems may comprise one or more computing devices that are connected over a wired and/or wireless communication medium. The medium may include any combination of wired transmission channels (e.g., fiber optic or traditional wire cables) and wireless channels (e.g., electromagnetic transmissions over frequency). This wired or wireless medium, the communication protocols used by the various computing devices, and intermediate devices between endpoints, may be referred to as a computer network. A server computing system may act as a server which determines, retains, and transmits data electronically over the computer network to a client. A server may have a variety of real-world applications which may interact with other servers, or serve as an endpoint that interacts with human users. These applications are numerous in type and scope, and may include operations related to controlling machinery, transportation, detecting weather, telecommunications, cellular networks, maintaining records, artificial intelligence, facilitating transactions, and more.

Server computing systems may be connected over the computer network for transmitting and sharing information. Each server computing system may perform one or more dedicated services. Computing devices connected to a computer network may include mobile devices, machinery, industrial equipment, household equipment, medical equipment, home computers, web servers, file servers, and more. A computer network may include network-specific devices such as routers, switches, firewalls, and more.

Server computing systems may be connected to a computer network, and interact with one or more clients to support movement of physical resources (e.g., oil, coal, gasoline, grain, metal, lumber, etc.) or digital resources (e.g., credits, funds, etc.), or both. Resources may be moved from a source to a destination. The source and/or destination may be a physical location, or a digital container (e.g., an account) which may require digital authorization to access. Server computing systems may facilitate numerous complex movements of resources for different clients in real-time (e.g., with minimal delay as the request is received from the client). In some cases, a server computing system may facilitate movement of an amount of a resource to a client. The client may return this resource through multiple resource movements.

### BRIEF DESCRIPTION OF THE DRAWINGS

The present disclosure will be understood more fully from the detailed description given below and from the accompanying drawings of various embodiments, which, however, should not be taken to limit the embodiments described and illustrated herein, but are for explanation and understanding only.

FIG. 1 illustrates an example of a server computing system for resource movement modeling with enhanced accuracy and reduced latency, in accordance with an embodiment.

FIG. 2 shows a flow diagram of a method for resource movement modeling with enhanced accuracy and low latency, in accordance with an embodiment.

FIG. 3 shows an example of resource graphs which may be used for resource movement modeling, in accordance with an embodiment.

FIG. 4 shows an example of models that may be used with determining a condition associated with a resource, in accordance with an embodiment.

FIG. 5 illustrates an example of a server computing system for model-based resource monitoring with factor-based adjustment and resource pool adjustment, in accordance with an embodiment.

FIG. 6 is one embodiment of a computer system that may be used to support the systems and operations described, in accordance with an embodiment.

### DETAILED DESCRIPTION

In the following description, numerous details are set forth. It will be apparent, however, to one of ordinary skill in the art having the benefit of this disclosure, that the embodiments described herein may be practiced without these specific details. In some instances, well-known structures and devices are shown in block diagram form, rather than in detail, in order to avoid obscuring the embodiments described herein.

Some portions of the detailed description that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “receiving”, “determining”, “storing”, “detecting”, “applying”, “transmitting”, “moving”, “transitioning”, “configuring”, “generating”, “releasing”, “increasing”, “decreasing”, or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices. Operations said to be performed automatically may refer to operations being performed based on logic or an algorithm executed by a computing device, without human input at the time of the operation or decision.

The embodiments discussed herein may also relate to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

The algorithms and displays presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will appear from the description below. In addition, the embodiments discussed herein are not described with reference to any particular programming language. It will be appreciated that a variety of programming languages may be used to implement the teachings as described herein.

Server computing systems may include one or more network nodes, each typically including a processor connected to a machine readable memory (e.g., non-transitory computer-readable memory). The memory can store machine executable instructions. Related instructions are grouped together as an application of software bundle. Some behavior of an application may be configured based on data that is outside of the instructions, such as configuration files, settings, inputs, outputs, etc. A server computing system may have a monolithic software architecture, where every functionality of the application is contained one bundle of machine executable instructions and performed by a single network node. Additionally, or alternatively, a server computing system may comprise a distributed computing platform that comprises a plurality of services (e.g., microservices), each being independently capable of being compiled, independently buildable (e.g., having a dedicated group of machine executable instructions), independently runnable, and independently deployable, thereby providing extensibility and flexibility in supporting resource movements.

A server computing system may be connected to a computer network, and interact with one or more clients to support movement of resources which may be physical, digital, or both. The system may track movement of physical resources (e.g., oil, coal, gasoline, grain, metal, lumber, etc.) through monitoring signals or messages over the computer network. The system may track and/or perform the movement of digital resources (e.g., credit, funds, etc.) by transmitting requests and receiving confirmation to one or more external digital systems. Server computing systems may control how much of a resource is available for release to users over the computer network, and do so in real time. The users may, in some cases, receive these resources with the expectation that they will return the resource to the source, which may be performed over a period of time in multiple movements of the resource back to the source. This resource may be returned to a pool where it may be made available to give to other users. A server computing system may be tasked with maintaining an amount of resource which may change depending on timing and amount of the resource which is predicted to be received by users holding the previously given resource. Estimating timing and amount of resource that will be received presents an issue because such a determination may be computationally heavy and vary from one user to the next. In cases where a server computing system comprises many different services, each dedicated a set of tasks but communicating and depending on each other to perform coordinated functionality, delay in one service (e.g., in estimating this resource return timing and amount) may ripple through the system and increase latency in the system, which may ultimately cause unwanted delays to an end user (e.g., a client), or create anomalies in data, or both. With a wide variety of different users that behave differently, estimating this timing and amount of receiving the resource may be inaccurate if not considering impactful factors such as an early window of behavior of the user. Further, user behavior may change over time and modeling this changing behavior is also computationally heavy, especially in real-time systems where latency is potentially introduced with each request to determine user behavior. As such, it is desirable for a server computing system which is capable of determining resource return behavior of users with reduced latency and enhanced accuracy.

Aspects of the present disclosure relate to a server computing system for modeling future return of a resource from a user. The server computing system analyzes signals to determine early movements of the resource associated with receiving the resource from the user. The server computing system may generate a graph that represents receiving this resource from the user over time. The server computing system may select a relevant segment of that graph, where this portion indicates a localized speed at which the resource is being received from the user over that portion of time. The server computing system selects a model from a plurality of pre-generated models based on that portion. Each of the models comprise parameters indicating an amount of the resource at different times with respect to one or more time-based factors such as lateness in receiving the resource, and each model is generated based on data associated with speed of receiving the resource. These pre-generated models may be generated and updated at an offline stage, in a manner decoupled from the processing and analysis of the signals, and processing of requests to determine the behavior associated with a given user and resource, thereby reducing computational overhead and latency for determining the behavior upon receiving a request. The model may characterize an amount of the resource received by the user at a target time in the future. Further, multiple models may be stacked, when necessitated, to extrapolate the predicted amount of the resource received by the user at further points in the future. Based on the predicted amount of the resource to be received, the server computing system may determine a condition associated with receiving the resource, such as, for example, a portion of the resource being received pass a threshold time, or not being received at all (e.g., a loss). The dedicated service may transmit this condition to another service of the server computing system, which may perform one or more actions based on this condition.

In such a manner, the server computing system may determine the condition of the resource with enhanced accuracy because the models used to determine this condition are selected based on the actual behavior of that user, with reduced computational overhead and latency due to leveraging pre-generated models and/or graphs.

In an aspect of the present disclosure, a server computing system is configured to perform operations comprising handling a request associated with a resource, detecting a first resource movement and a second resource movement associated with receiving the resource from a user, and generating a graph associated with a speed of receiving the resource, based on the first resource movement and the second resource movement. The server selects one of a plurality of models, based on the graph, the selected model comprising an association between a first amount of the resource at a first time and a second amount of the resource at a second time that is after the first time. The server determines a condition associated with the resource based on the model and a current amount of the resource, and responds to the request with the condition associated with the resource.

In an aspect, the server computing system includes a plurality of services, where a first service of the plurality of services is configured to perform operations including: receiving, from a second service of the plurality of services, a request associated with a resource; detecting a first resource movement and a second resource movement associated with receiving the resource from a user; generating a graph associated with a speed of receiving the resource, based on the first resource movement and the second resource movement; selecting a model from among a plurality of models, based on the graph, where the model includes an association between a first amount of the resource at a first time and a second amount of the resource at a second time that is after the first time; determining a condition associated with the resource based on the model and a current amount of the resource, and transmitting the condition associated with the resource to the second service.

In an embodiment, each of the plurality of models includes a first axis associated with a state of lateness of receiving the resource at the first time, and a second axis associated with a second state of lateness of receiving the resource at the second time. In an embodiment, a cross section between the first axis at the first time and the second axis at the second time includes a weight indicating a predicted amount of the resource that will be received late from the first time to the second time. In an embodiment, determining the condition associated with the resource based on the model includes applying the weight associated with the predicted amount of the resource to the current amount of the resource.

In an embodiment, determining the condition associated with the resource based on the model further includes applying a second weight to the second amount based on at least one of: an offboarding of the user from a digital platform, a characteristic of the user, or a most recent receiving of the resource.

In an embodiment, generating the graph includes mapping a speed of the first resource movement and the second resource movement to a first graph and a second graph selected from a plurality of graphs, and generating the graph based on the first graph and the second graph. In an embodiment, generating the graph includes determining the graph as a weighted average of the first graph and the second graph. In an embodiment, each of the plurality of graphs are associated with an overall amount of the resource that is received with respect to time. The plurality of graphs may also be generated offline, and updated based on monitored receiving of resources from different users, thereby updating and maintaining accuracy of the model selection process over time.

In an embodiment, the operations further comprise monitoring the receiving of the resource associated with a plurality of other users, and update the plurality of models based on the monitored receiving of the resource. These models are updated according to recent data, making the model a more accurate representation of user behavior, thereby maintaining accuracy of determining the condition associated with the resource using the models.

In an embodiment, the operations further comprise increasing or decreasing a storage pool of the resource based on the condition associated with the resource, and transmitting an additional resource amount from the storage pool to an external computing system associated with another user. For example, if this condition satisfies a threshold, then the server computing system can add more resource to the storage pool, or increase a target amount of the storage pool, to account for this condition and reduce the risk that the amount of resource in the storage pool drops below a threshold amount (e.g., zero, or a low threshold amount).

Other technical features may be readily apparent to one skilled in the art from the following figures, descriptions, and claims.

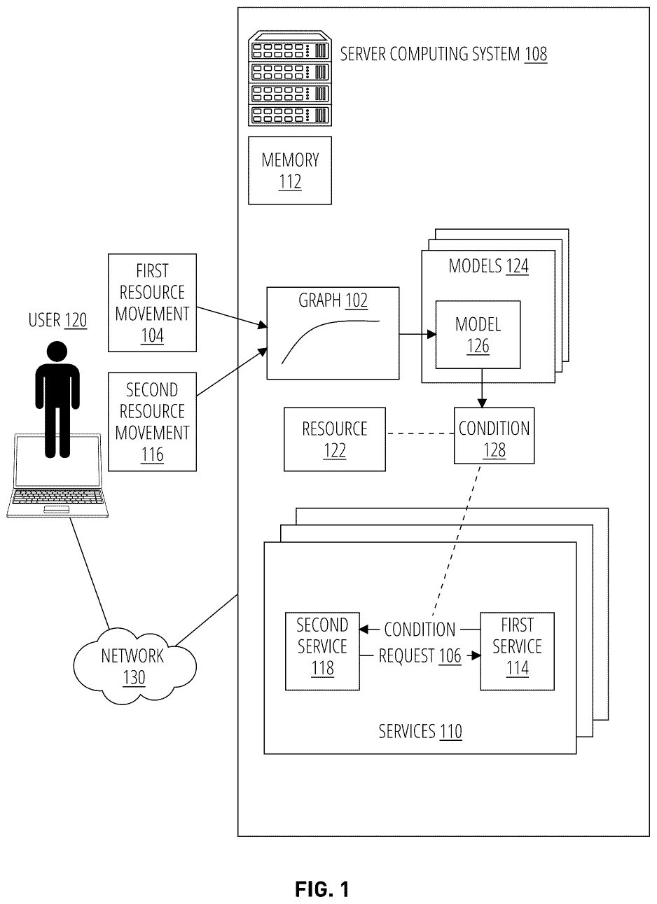

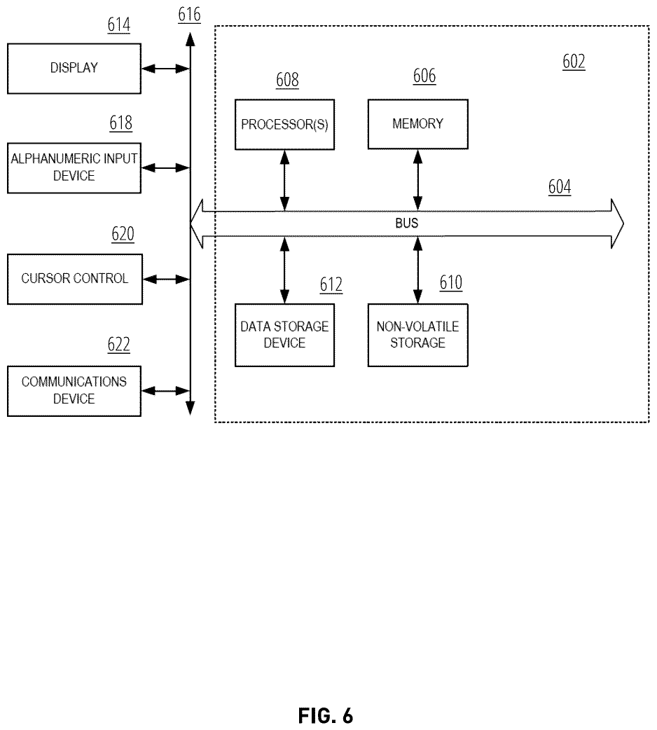

FIG. 1 illustrates an example of a server computing system for resource movement modeling with enhanced accuracy and reduced latency, in accordance with an embodiment. Server computing system 108 may comprise a plurality of services 110. Each of the plurality of services 110 may be independently buildable, runnable, and deployable. Each may comprise a dedicated set of compute resources (e.g., memory 112, processor resources, etc.). In an embodiment, services 110 may be referred to as microservices. In an embodiment, each of the services 110 may comprise one or more exposed application programming interfaces (API). The services 110 may communicate with each other over a dedicated backplane (e.g., over a computer network 130) and may request operations of each other through agreed upon defined API calls with agreed upon parameters and behavior. Server computing system 108 may comprise one or more data processing systems, such as shown in FIG. 6.

Generally, a plurality of services 110 of the server computing system 108 may work together to provide a desired and encapsulated functionality to a user 120. The functionality may include a user interface (not shown) and/or an API for user 120 to communicate with server computing system 108 over a network 130. For example, the user 120 may operate a network node and transmit a request to server computing system 108 to receive resource 122. The server computing system 108 may transmit the resource 122 to the user 120 or transmit an authorization to an external computing system (not shown) to authorize transmission of the resource 122.

The server computing system 108 may determine status of receiving the resource 122 back from user 120. The resource 122 may be returned back to its source (e.g., the server computing system 108 or a remote computing system).

A first service 114 may receive from a second service 118, a request 106 associated with the resource 122. Such a request may be transmitted and received over network 130. In an example, the request 106 may be received over a communication backplane dedicated to services 110. In response to receiving the request 106, the first service 114 may utilize models 124 to determine a condition 128 that is associated with resource 122.

The first service 114 may detect a first resource movement 104 and a second resource movement 116 associated with receiving the resource from a user. For example, first service 114 may access data (e.g., in a database, a log, network traffic, etc.) which indicates when a user 120 has transmitted resource 122 back to its source. The first service 114 may determine that a first resource movement 104 and second resource movement 116 was received from the user 120, and when these resource movements occurred.

The first service 114 may generate a graph 102 associated with a speed of receiving the resource 122 back from the user 120, based on the first resource movement and the second resource movement. In an embodiment, generating the graph 102 includes mapping a speed of the first resource movement and the second resource movement to a first graph and a second graph selected from a plurality of graphs, and generating the graph based on the first graph and the second graph. In an embodiment, generating the graph includes determining the graph as a weighted average of the first graph and the second graph. Each of the plurality of graphs may be associated with an overall amount of the resource that is received with respect to time. The first service 114 may therefore use the early return behavior of user 120 to select the closest graphs (the first graph and the second graph), and then generate a tailored graph as an average of the two. The plurality of graphs may be generated offline, and updated based on monitored receiving of resources from different users, thereby updating and maintaining accuracy of the model selection process over time, while reducing real-time latency of responding to request 106, the overhead of generating the graph 102 is reduced using the pre-generated graphs as a basis.

The first service 114 may select a model 126 from among a plurality of models 124, based on the graph 102. The model 126 includes an association between a first amount of the resource 122 at a first time and a second amount of the resource at a second time that is after the first time.

The first service 114 may determine the condition 128 that is associated with the resource 122, based on the model 126 and a current amount of the resource 122. For example, the first time may correspond to a current time, and the second time may correspond to a future time. This current amount may correspond to a current amount of resource 122 that has not been received back from user 120 (e.g., a balance amount) at the current time. The condition 128 may comprise a second amount which is predicted to not be received back from the user 120 at the second time. The condition 128 may indicate a risk that the second amount is under a threshold amount, for example, that the predicted balance at the second time does not meet the threshold amount.

The first service may transmit the condition 128 that is associated with the resource 122 to the second service 118. The time between receiving the request 106 and transmitting the condition 128 back to the second service 118 may be referred to as a latency. The computational overhead and processing time to detect and use the first resource movement 104 and second resource movement 116 to generate a graph 102 is relatively quick. Further, by selecting among pre-generated plurality of models 124, the server computing system 108 need not generate this model on the fly. The use of the graph and model enhances accuracy because the graph generation quickly determines a speed at which user 120 is returning the resource 122, and the model 126 is selected based on that speed and accurately extrapolates the condition 128 using data in the model that accurately models user behavior.

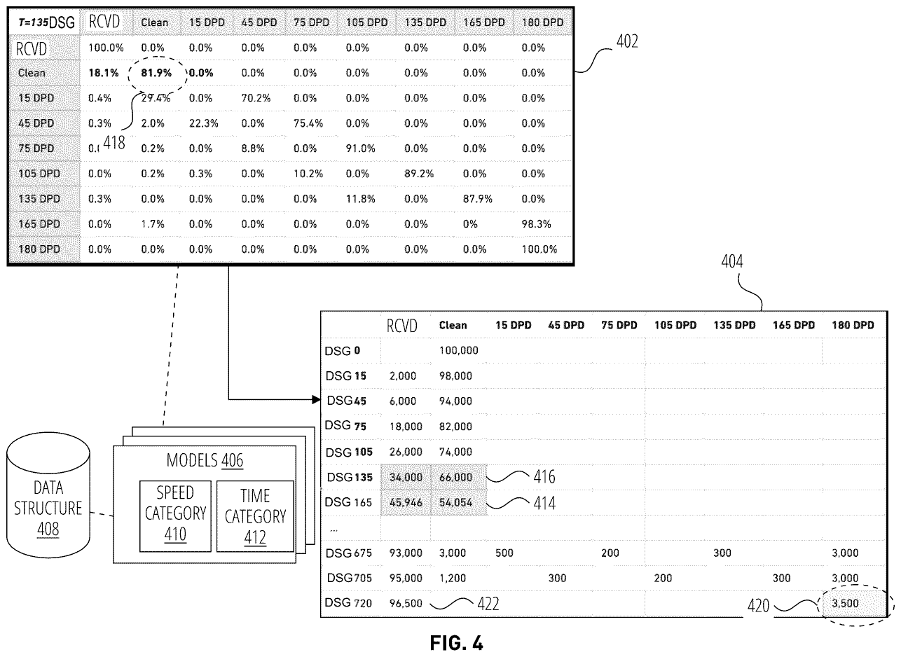

In an embodiment, each of the plurality of models 124 comprises a matrix (e.g., a transition matrix, as described further in FIG. 4). Each model may comprise a first axis (e.g., rows) associated with a state of lateness of receiving the resource at the first time, and a second axis (e.g., columns) associated with a second state of lateness of receiving the resource at the second time. In an embodiment, a cross section between the first axis at the first time and the second axis at the second time includes a weight indicating a predicted amount of the resource that will be deemed late from the first time to the second time. For example, a row on the first axis may represent a portion of the total resource given to a user as being deemed past due by X days. A column on the second axis may represent a predicted portion of the total resource given to a user as being deemed past due by X +Y days, and the cross-section of the row with the column holds a weight representing the state of the resource held by the user from time X to time Y. The cross section of a first point (corresponding to a first time) on the first axis and a second point (corresponding to a second time) on the second axis may include a weight that indicates how much of the resource is predicted to be received by the user 120 at the second time. In an embodiment, determining the condition 128 associated with the resource 122 based on the model 126 includes applying the weight associated with the predicted amount of the resource to the current amount of the resource 122. For example, the current amount of the resource 122 may be a remaining amount of the resource 122 that was previously transmitted or provided to user 120 that has not yet been received back from user 120. The first service 114 may determine condition 128 by applying the weight (e.g., with multiplication, division, etc.) to this remaining amount of the resource 122 that was previously given to user 120 and expected back, to predict the result which is an amount of the resource given to the user and expected to extend into being late.

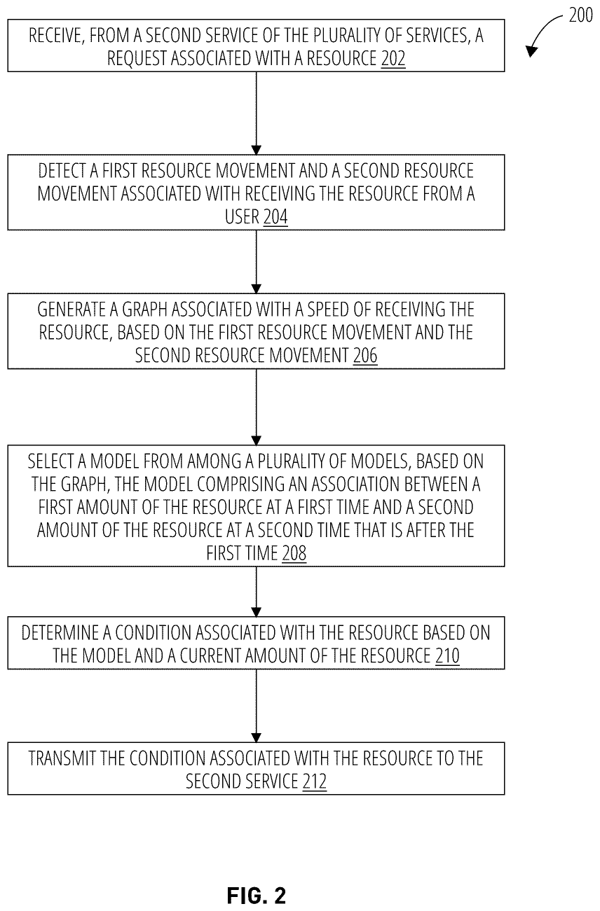

FIG. 2 shows a flow diagram of a method for resource movement modeling with enhanced accuracy and low latency, in accordance with an embodiment.

The method 200 may be performed by processing logic that may comprise hardware (circuitry, dedicated logic, etc.), software (such as is run on a general purpose computer system or a dedicated machine), firmware, or a combination. Processing logic may comprise a plurality of processors operating in a distributed computing architecture (e.g., a plurality of services that may be distributed over different servers on a computer network). Each service may be a self-contained buildable and deployable set of machine-executable instructions with dedicated computer resources such as processors, processor bandwidth, network transceiver resources, computer memory, etc. Method 200 may be performed by a server computing system or one or more services thereof, as described in other sections.

At block 202, method 200 receives, from a second service of the plurality of services, a request associated with a resource. In an embodiment, the request may be a service to service request, transmitted over a dedicated and private network (e.g., a microservices backplane). In an embodiment, the request is performed with a dedicated API having a pre-defined format. In an embodiment, the API call is received with an API token, and the receiving service authenticates the request with the token. The method may drop the request in response to the request being invalidated. This may protect the system from errant requests from potential cyber-attacks.

At block 204, method 200 detects a first resource movement and a second resource movement associated with receiving the resource from a user. In an embodiment, the method 200 may detect the resource movements by accessing a log or database at predefined times T1 and T2. In an embodiment, the method 200 may detect two or more resource movements. Each resource movement may correspond to a user returning a first amount and a second amount of the resource back to a source that gave this resource to the user. In an embodiment, the resource is transmitted to the user electronically (e.g., through a computer network), and received back from the user electronically (e.g., through a computer network).

At block 206, method 200 generates a graph associated with a speed of receiving the resource, based on the first resource movement and the second resource movement. As described, method 200 may access a plurality of graphs, generated at an off-line stage based user behavior. The method may find a first graph and a second graph that best fit the first resource movement and the second resource movement (and/or additional resource movements). In an embodiment, the method may generate the graph based on combining the first graph and the second graph (e.g., as an average or weighted average).

At block 208, method 200 selects a model from among a plurality of models, based on the graph, the model comprising an association between a first amount of the resource at a first time and a second amount of the resource at a second time that is after the first time. In an embodiment, each of the plurality of models is a matrix, which can also be referred to as a transition matrix. A weight may be located at a cross section of the first time and the second time, where the weight may represent a percentage of a remaining amount of the resource not yet received, that is predicted to be late at the second time.

At block 210, method 200 determines a condition associated with the resource based on the model and a current amount of the resource. In an embodiment, this condition may be associated with a remaining amount of the resource not yet received, that is predicted to be late at the second time. This may be determined by applying the weight from the selected model to the existing total remaining amount of the resource not yet received at a current time. In an embodiment, the condition may represent a determined loss. For example, if the remaining amount of the resource not yet received at the future time satisfies a threshold (e.g., a time threshold, an amount threshold, or both), then the remaining amount or portion thereof may be determined as a loss.

At block 212, method 200 transmits the condition that is associated with the resource to the second service. As discussed, in an embodiment, this condition may comprise the remaining amount of the resource that is predicted to be late at future time. In an embodiment, this condition may be a determined loss associated with the resource. In an embodiment, in response to the condition satisfying a threshold, the method (e.g., the second service) may change a resource pool amount. For example, in response to determining or predicting that a loss will be associated with the resource, the method may increase a resource pool amount. This increase can correspond to (e.g., be equal to or proportional to) the predicted loss.

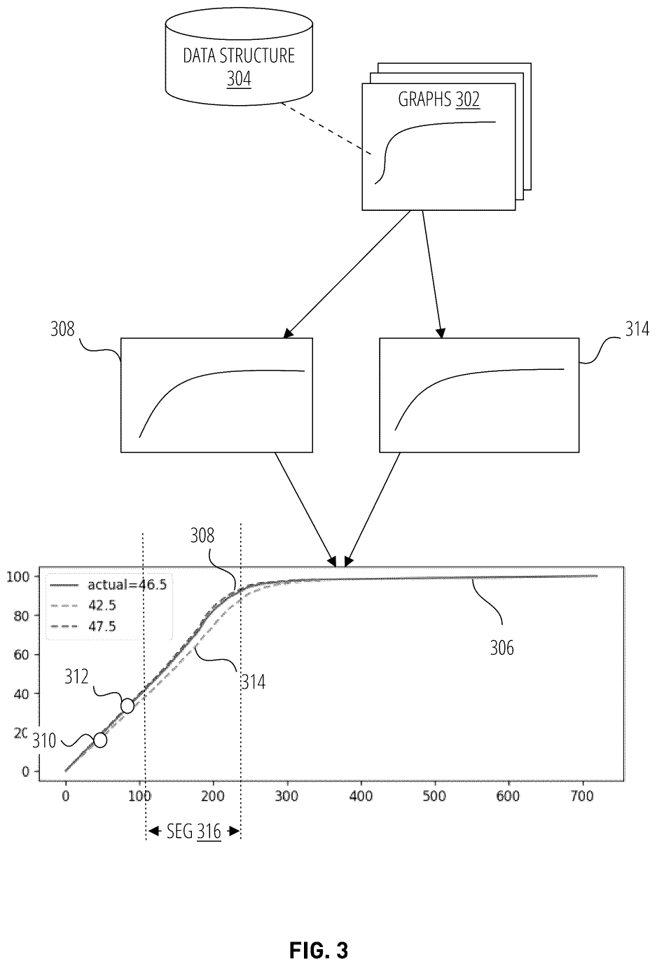

FIG. 3 shows an example of resource graphs which may be used for resource movement modeling, in accordance with an embodiment. Graphs 302 may correspond to graphs described in other sections and with respect to the other figures.

Graphs 302 represent the speed at which a resource is being returned by a user, for example, to the original source that gave the resource to the user. An X axis of each graph may represent a time since the resource was initially given to the user. A Y axis of each graph may represent a cumulative percentage of the amount of resource returned, with respect to the original amount given to the user (amount received/original amount given). Graphs 302 may be pre-generated based on historical data, which may comprise records of detailing the speed at which users have historically returned the resource. Graphs 302 may be stored in a data structure 304, which may comprise a structured database, a structured file format, a lookup table, a dictionary, or text or log file, or other digitally storage format.

In an embodiment, a server computing system may access graphs 302 and determine a graph that best approximates a resource return profile of a user, based on a first resource movement 310 and a second resource movement 312. For example, a server computing system may search graphs 302 to find one or more, or two or more closest graphs that best fit to the first resource movement 310 and second resource movement 312. In an example, server computing system may find the best fit based on which of the graphs has the lowest distance to the movements 310 and 312 along the line of the graph.

In an embodiment, the first resource movement 310 and second resource movement 312 are a first minimum resource return and second minimum resource return that are required of the user to return to the source of the resource at predefined respective times. A server computing system as described in other sections may access data associated with a particular resource provided to a user, and scan the data to determine when the first resource movement 310 and second resource movement 312 occurred, and the amount of each respective resource. If they each satisfy a threshold (e.g., amount and time), then these movements may be selected and used to select first graph 308 and second graph 314 that best fit these points.

Graphs 302 may each represent a cumulative percentage of the amount of resource returned, with respect to the original amount given to the user, as discussed. The x axis of the graph may start at the time that the resource was first given to the user. The y graph may represent how much of the resource has been received from the user over time. For example, as shown in FIG. 3, graph 308 may indicate a value of 47.5 representing a percentage of the total resource that has been returned at time X relative to the total amount given to the user. The graph 314 has a slightly different profile, with value of 42.5 at the same time X. The server computing system may generate graph 306 by combining graph 308 and 314 (e.g., as a weighted average of the two), which yields a graph that is between graphs 308 and 314, and has a value of 46.5 at time X.

The server computing system may select a segment 316 of the graph 306 based on a corresponding current time. For example, if the current date is Y days since the resource was given to the user, segment 316 may be a window of time on the graph 306 that covers the current number of days since the resource was given to the user. The server computing system may determine a speed of the graph at this point, and then select a corresponding model based on this speed and this time. For example, if the speed (e.g., a slope of the graph) is within a first range, then a corresponding ‘slow’ model is selected that comprises data corresponding to the time window of Y days. If the speed is within a second range, then a corresponding ‘medium’ model is selected that comprises data corresponding to the time window of Y days. If the speed is within a third range, then a corresponding ‘fast’ model is selected that comprises data corresponding to the time window of Y days, and so on.

In an embodiment, graphs 302 are updated dynamically. For example, the server computing system may automatically scan data that is associated with users receiving a resource from a source, and receiving that resource back from the users over time. The server computing system may perform this scanning periodically or based on an event (e.g., a notification that a database has been updated), and generate updated graphs 302 or new graphs 302 when data points are detected to be different from those already stored in existing graphs 302. The server computing system may communicate with external computing systems over a computer network (e.g., via an API, web-crawling, etc.) to access and scan this data.

FIG. 4 shows an example of models that may be used with determining a condition associated with a resource, in accordance with an embodiment.

Models 406 may comprise a plurality of different models, each characterizing how different categories of users with respect speed of receiving a given resource back from a user at different times within each model. Each of the models 406 may be associated with a respective speed category 410 and time category 412. As described in other sections, a server computing system may determine a graph based on early movements of a resource, and determine a speed of a segment of the graph. The speed of the graph and the time of that speed segment is used to select a corresponding model 402 based on the matching speed category 410 and time category 412 of the model 402. For example, if the segment of a graph covers time T since the resource was given to a user, the speed of that segment is used to select a matching speed category 410 (e.g., slow, medium, fast), and matching time category 412 (e.g., a range of time N to time M which encompasses time T).

Models 406 may be stored in a data structure 408, such as a structured database, a log, formatted file, etc. In an embodiment, data structure 408 is maintained and updated by a dedicated service of the server computing system in an off-line stage, and another dedicated service (e.g., a first service) may handle requests to determine, in real-time, the condition associated with a specified resource.

In an embodiment, each of the models 406 may comprise an association between a first amount of the resource at a first time and a second amount of the resource at a second time that is after the first time. Each of the plurality of models comprises a first axis associated with a state of lateness of receiving the resource at the first time, and a second axis associated with a second state of lateness of receiving the resource at the second time. A cross section between the first axis (e.g., rows) at the first time and the second axis (e.g., columns) at the second time comprises a weight indicating a predicted amount of the resource that will be received late from the first time to the second time.

In an embodiment, each of the models 406 may be referred to as a transition matrix. Each column may represent a lateness state of a given resource as of time T+30 days since given (DOB). Each column may be mutually exclusive, for example, the amount of resource still to be returned could only be in one state. It should be understood that, instead of T+30 days, each column may represent a T+ interval, where ‘interval’ may represent any suitable time interval (e.g., 10 days, 15 days, 30

[symbol]

Each row may represent a lateness state as of time T days since given. Each row sums up to 100%. The value held in the cross section between a row and a column may represent a percentage of the total amount of the resource still to be received, that is transitioning from the row state specified as of time T days, to the column state as of T+30 days. The server computing system may determine which row and column is applicable to a given request.

For example, when a server computing system receives a request to determine a condition associated with a resource, the server computing system may generate the graph, and select the model 402 based on the graph (e.g., a corresponding speed category 410 and time category 412). For example, model 402 may be selected based on the speed category 410 being ‘medium’, and the relevant time category 412 being 135 days since the resource was originally given to the user. The server computing system may determine which row of model 402 is relevant to the request, for example, if the receiving of the resource is currently deemed to be late 45 days, the server computing system may select the row corresponding to 45 days (45 DPD) and the column of the next time period (75 DPD) to predict that 75.4% of the remaining amount of resource to be returned will still be late at the next time period (in 30 days, in this example).

In addition, the server computing system may extrapolate this prediction to determine future values. For example, models 406 may comprise one model (e.g., transition matrix) for every 30-day window. In the example shown, model 402 may represent transition of resource status from 135 days to 165 days. Models 406 may further comprise models of additional time periods (e.g., 165 days to 195 days, 195 days to 225 days, and so on, until a threshold number of days (since the resource was given to the user). For example, assuming that the server computing system takes the value at intersection 418 illustrated in the table 404, the amount determined from model 402 as of 135 days may be multiplied with the current amount of the resource that is yet to be received shown at 416, to obtain a second value 414 at a next time period (165 days), using the model 402. The server computing system may repeat this process multiple times: e.g., 165 days value of the resource to be returned, multiplied by the relevant value pulled from a 165 to 195 day transition matrix, to obtain the 195 day amount, and so on, until the server computing system determines the amount of the resource 422 returned at a final time. The loss 420 is determined as the remaining amount of the resource predicted to be late at this final time. This loss 420 may be the condition that is returned in response to the request that is associated with the resource. The server computing system may then perform one or more actions based on this condition, such as generate an alert, increase a resource pool amount, etc.

In an embodiment, each model 406 may comprise a received (RCVD) and clean (Clean) row and column. The received column represents an amount (e.g., percentage) of resource that is expected to be received by a user in the next 30-days and not deemed to be late. The clean column and row represents an amount (e.g., percentage) of the resource that is to be received and not deemed late (e.g., the resource is being received from the user faster than a minimum threshold). In an embodiment, each model comprises a final intersection (e.g., 180DPD) representing the amount (e.g., percentage) that is 180+ days late. RCVD and 180 DPD are two states that are irreversible, the values are shown as 100% at the upper left and lower right corners as the amount of resource in these two states that cannot roll to other states.

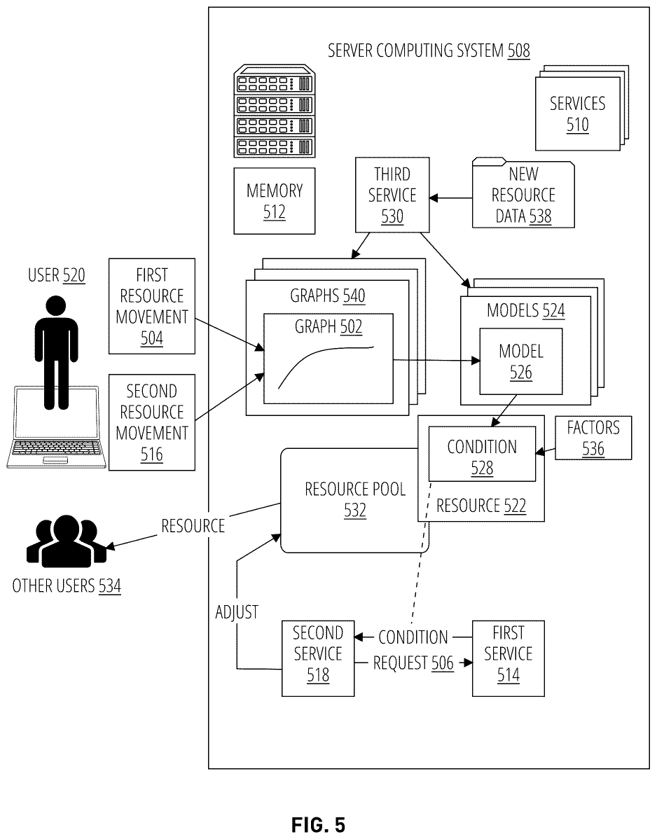

FIG. 5 illustrates an example of a server computing system for model-based resource monitoring with factor-based adjustment and resource pool adjustment, in accordance with an embodiment. Server computing system 508 may comprise a plurality of services 510. Each of the plurality of services 510 may be independently buildable, runnable, and deployable. Each may comprise a dedicated set of compute resources (e.g., memory 512, processor resources, etc.). The services 510 may communicate with each other over a dedicated backplane (e.g., over a computer network) and may request operations of each other through well-defined API calls with agreed upon parameters and behavior. Aspects described with respect to server computing system 508 may correspond to aspects described in other sections and other figures.

Server computing system 508 may comprise a plurality of services 510 which may include a first service 514 and second service 518. The first service 514 may receive a request 506 associated with a resource 522. This resource 522 may have been previously given from a source (e.g., resource pool 532) to a user 520. First service 514 may detect a first resource movement 504 and a second resource movement 516 associated with receiving the resource from a user. In an embodiment, the first resource movement 504 may be a first minimum amount of resource required and received at a first time, and the second resource movement 516 may be a second minimum amount of the resource required and received at a second time.

The first service 514 may generate graph 502 based on the first resource movement 504 and the second resource movement 516. Graph 502 may be associated with a speed of receiving the resource, and given that it is based on the actual detected behavior of user 520, this graph may accurately determine the condition 528 associated with the resource 522. Server computing system 508 may generate graph 502 based on a plurality of graphs 540, such as, for example, described in other sections.

The first service 514 may select a model 526 from among a plurality of models 524, based on the graph 502. The model 526 may comprise an association between a first amount of the resource at a first time and a second amount of the resource at a second time that is after the first time. In an embodiment, each of the plurality of models 524 may comprise a first axis associated with a state of lateness of receiving the resource at the first time, and a second axis associated with a second state of lateness of receiving the resource at the second time, as described in other sections. A cross section between the first axis at the first time and the second axis at the second time comprises a weight indicating a predicted amount of the resource that will be received late from the first time to the second time. In an embodiment, determining the condition associated with the resource based on the model comprises applying the weight associated with the predicted amount of the resource to the current amount of the resource that has not been received back from the user. For example, using FIG. 4 as an example, model 402 shows the cross section of 105 days late and 135 days late holding a weight of 89.2% which can be applied to a current total amount of resource that has not yet been received back from user, to determine a predicted amount of the resource that will be late at the next time period of 165 days since the resource was given to the user.

In an embodiment, determining the condition 528 associated with the resource based on the model further comprises applying a second weight to the second amount based on one or more factors 536 comprising: an offboarding of the user from a digital platform, a characteristic of the user, or a most recent receiving of the resource. The second weight may be representative of these one or more factors 536 that can further weigh on this condition.

For example, referring back to FIG. 4, if the condition 528 is determined as a predicted loss 420 of the resource, this loss amount 420 may be adjusted higher or lower based on the one or more factors above. If user 520 has been detected as offboarding (e.g., digitally performing an operation to close a user account) with the server computing system 508, the server computing system 508 may increase the predicted loss 420. Additionally, or alternatively, the server computing system 508 may increase or decrease the loss amount 420 based on an age range or other characteristic of the user. Additionally, or alternatively, the server computing system 508 may decrease this predicted loss in response to detecting that the resource is received within a threshold time with respect to the current time, and/or increase this predicted loss in response to detecting that the resource has not been received within a threshold period of time with respect to the current time.

The first service 514 may determine a condition 528 associated with the resource 522, based on the model 526 and a current amount of the resource 522 (e.g., a total amount of the resource given to the user, or the total amount of the resource that has been received back from the user, or both).

The first service 514 may transmit the condition 528 associated with the resource to the second service.

In an embodiment, server computing system 508 may monitoring receiving of the resource associated with a plurality of other users 534. Server computing system 508 may updating the plurality of models 524 and/or the graphs 540 based on the monitored receiving of the resource. For example, server computing system 508 may comprise a third service 530 that retrieves data associated with resources given to and received back from each of users 534 on a per user basis. This data may be stored as new resource data 538 and analyzed by third service 530 to generate new graphs 540. For example, third service 530 may generate a plurality of different graphs 540 by plotting the speed at which each of the users 534 return their resource respectively over time. New models 524 may similarly be generated to each best fit the behavior of return of the resource by the users 534 in aggregate, according to the different speed categories. Third service 530 may perform this analysis of new resource data 538 and generation of graphs 540 and models 524 as being decoupled from handling of request 506. For example, third service 530 may perform this in an offline stage so that, when the request 506 is received by first service 514, these graphs 540 and models 524 are updated and ready to be used to determine condition 528, thereby reducing latency in handling response 506.

Second service 518 may receive condition 528 and, if the condition satisfies a threshold, increase or decrease a resource pool 532 which holds the resource 522 to give to users. For example, in response receiving the condition as a loss that exceeds a threshold amount, second service 518 may increase the size of the resource pool 532 to reduce the risk that the amount of resource in the resource pool 532 falls below a threshold amount. Conversely, in response to receiving the condition as a loss that is smaller than a threshold amount (e.g., zero), the second service 518 may reduce the amount of resource in the resource pool, so that the resource may be allocated elsewhere if needed. The server computing system 508 may, in some embodiments, digitally control the transmission and receiving of resource amount to and from the resource pool 532, from and to users 534. The server computing system 508 may be the source of the resource to the users 534, 520, in this example. Additionally, or alternatively, the resource pool 532 may be controlled by an external device on a computer network, which may be communicatively coupled to server computing system 508.

FIG. 6 is one embodiment of a computer system (e.g., a data processing system) that may be used to support the systems and operations described, in accordance with an embodiment. For example, the computer system illustrated in FIG. 6 may be used server computing system to determine a condition associated with a resource based on user behavior, as described in other sections. It will be apparent to those of ordinary skill in the art, however that other alternative systems of various system architectures may also be used.

The computer system 602 illustrated in FIG. 6 includes a bus or other internal communication means 604 for communicating information, and one or more processors 608 coupled to the bus 604 for processing information. The system further comprises a random access memory (RAM) or other volatile storage device 606 (referred to as memory), coupled to bus 604 for storing information and instructions to be executed by processor 608. Main memory 606 also may be used for storing temporary variables or other intermediate information during execution of instructions by processor 608. The system also comprises a read only memory (ROM), non-volatile storage, and/or static storage device 610 coupled to bus 604 for storing static information and instructions for processor 608, and a data storage device 612 such as a magnetic disk or optical disk and its corresponding disk drive. Data storage device 612 is coupled to bus 604 for storing information and instructions.

The system may further be coupled to a display device 614, such as a light emitting diode (LED) display or a liquid crystal display (LCD) coupled to bus 604 through bus 616 for displaying information to a computer user. An alphanumeric input device 618, including alphanumeric and other keys, may also be coupled to bus 604 through bus 616 for communicating information and command selections to processor 608. An additional user input device is cursor control device 620, such as a touchpad, mouse, a trackball, stylus, or cursor direction keys coupled to bus 604 through bus 616 for communicating direction information and command selections to processor 608, and for controlling cursor movement on display device 614.

Another device, which may optionally be coupled to computer system 602, is a communication device 622 for accessing other nodes of a distributed system via a network. The communication device 622 may include any of a number of commercially available networking peripheral devices such as those used for coupling to an Ethernet, token ring, Internet, or wide area network. The communication device 622 may further be a null-modem connection, or any other mechanism that provides connectivity between the computer system 602 and the outside world. Note that any or all of the components of this system illustrated in FIG. 6 and associated hardware may be used in various embodiments as discussed herein.

It will be appreciated by those of ordinary skill in the art that any configuration of the system may be used for various purposes according to the particular implementation. The control logic or software implementing the described embodiments can be stored in main memory 606, mass storage device 612, or other storage medium locally or remotely accessible to processor 608.

It will be apparent to those of ordinary skill in the art that the system, method, and process described herein can be implemented as software stored in main memory 606 or read only memory and executed by processor 608. This control logic or software may also be resident on an article of manufacture comprising a computer readable medium having computer readable program code embodied therein and being readable by the mass storage device 612 and for causing the processor 608 to operate in accordance with the methods and teachings herein.

The embodiments discussed herein may also be embodied in a handheld or portable device containing a subset of the computer hardware components described above. For example, the handheld device may be configured to contain only the bus 604, the processor 608, and memory 606 and/or 612. The handheld device may also be configured to include a set of buttons or input signaling components with which a user may select from a set of available options. The handheld device may also be configured to include an output apparatus such as a liquid crystal display (LCD) or display element matrix for displaying information to a user of the handheld device. Conventional methods may be used to implement such a handheld device. The implementation of embodiments for such a device would be apparent to one of ordinary skill in the art given the disclosure as provided herein.

The embodiments discussed herein may also be embodied in a special purpose appliance including a subset of the computer hardware components described above. For example, the appliance may include a processor 608, a data storage device 612, a bus 604, and memory 606, and only rudimentary communications mechanisms, such as a small touch-screen that permits the user to communicate in a basic manner with the device. In general, the more special-purpose the device is, the fewer of the elements need be present for the device to function.

It is to be understood that the above description is intended to be illustrative, and not restrictive. Many other embodiments will be apparent to those of skill in the art upon reading and understanding the above description. The scope should, therefore, be determined with reference to the appended claims, along with the full scope of equivalents to which such claims are entitled.

The foregoing description, for purpose of explanation, has been described with reference to specific embodiments. However, the illustrative discussions above are not intended to be exhaustive or to limit the described embodiments to the precise forms disclosed. Many modifications and variations are possible in view of the above teachings. The embodiments were chosen and described in order to best explain the principles and practical applications of the various embodiments, to thereby enable others skilled in the art to best utilize the various embodiments with various modifications as may be suited to the particular use contemplated.

What is claimed is:

1. A server computing system comprising a plurality of services, wherein a first service of the plurality of services is configured to perform operations comprising:
receiving, from a second service of the plurality of services, a request associated with a resource;
detecting a first resource movement and a second resource movement associated with receiving the resource from a user;
generating a graph associated with a speed of receiving the resource, based on the first resource movement and the second resource movement;
selecting a model from among a plurality of models, based on the graph, the model comprising an association between a first amount of the resource at a first time and a second amount of the resource at a second time that is after the first time;
determining a condition associated with the resource based on the model and a current amount of the resource; and
transmitting the condition associated with the resource to the second service.

2. The server computing system of claim 1, wherein each of the plurality of models comprises a first axis associated with a state of lateness of receiving the resource at the first time, and a second axis associated with a second state of lateness of receiving the resource at the second time.

3. The server computing system of claim 2, wherein a cross section between the first axis at the first time and the second axis at the second time comprises a weight indicating a predicted amount of the resource that will be received late from the first time to the second time.

4. The server computing system of claim 3, wherein determining the condition associated with the resource based on the model comprises applying the weight associated with the predicted amount of the resource to the current amount of the resource.

5. The server computing system of claim 4, wherein determining the condition associated with the resource based on the model further comprises applying a second weight to the second amount based on at least one of: an offboarding of the user from a digital platform, a characteristic of the user, or a most recent receiving of the resource.

6. The server computing system of claim 1, wherein generating the graph comprises mapping a speed of the first resource movement and the second resource movement to a first graph and a second graph selected from a plurality of graphs, and generating the graph based on the first graph and the second graph.

7. The server computing system of claim 6, wherein generating the graph comprises determining the graph as a weighted average of the first graph and the second graph.

8. The server computing system of claim 6, wherein each of the plurality of graphs are associated with an overall amount of the resource that is received with respect to time.

9. The server computing system of claim 1, further comprising:
monitoring receiving of the resource associated with a plurality of other users; and
updating the plurality of models based on the monitored receiving of the resource.

10. The server computing system of claim 1, wherein the operations further comprise:
increasing or decreasing, by the second service, a storage pool of the resource based on the condition associated with the resource; and
transmitting an additional resource amount from the storage pool to an external computing system associated with another user.

11. A non-transitory computer readable medium storing instructions that, when executed by one or more processing devices of a server computing system comprising a plurality of services, causes a first service of the plurality of services to perform operations comprising:
receiving, from a second service of the plurality of services, a request associated with a resource;
detecting a first resource movement and a second resource movement associated with receiving the resource from a user;
generating a graph associated with a speed of receiving the resource, based on the first resource movement and the second resource movement;
selecting a model from among a plurality of models, based on the graph, the model comprising an association between a first amount of the resource at a first time and a second amount of the resource at a second time that is after the first time;
determining a condition associated with the resource based on the model and a current amount of the resource; and
transmitting the condition associated with the resource to the second service.

12. The non-transitory computer readable medium of claim 11, wherein each of the plurality of models comprises a first axis associated with a state of lateness of receiving the resource at the first time, and a second axis associated with a second state of lateness of receiving the resource at the second time.

13. The non-transitory computer readable medium of claim 12, wherein a cross section between the first axis at the first time and the second axis at the second time comprises a weight indicating a predicted amount of the resource that will be received late from the first time to the second time.

14. The non-transitory computer readable medium of claim 13, wherein determining the condition associated with the resource based on the model comprises applying the weight associated with the predicted amount of the resource to the current amount of the resource.

15. The non-transitory computer readable medium of claim 14, wherein determining the condition associated with the resource based on the model further comprises applying a second weight to the second amount based on at least one of: an offboarding of the user from a digital platform, a characteristic of the user, or a most recent movement of the resource.

16. A method, performed by a first service of a plurality of services, comprising:
receiving, from a second service of the plurality of services, a request associated with a resource;
detecting a first resource movement and a second resource movement associated with receiving the resource from a user;
generating a graph associated with a speed of receiving the resource, based on the first resource movement and the second resource movement;
selecting a model from among a plurality of models, based on the graph, the model comprising an association between a first amount of the resource at a first time and a second amount of the resource at a second time that is after the first time;
determining a condition associated with the resource based on the model and a current amount of the resource; and
transmitting the condition associated with the resource to the second service.

17. The method of claim 16, wherein each of the plurality of models comprises a first axis associated with a state of lateness of receiving the resource at the first time, and a second axis associated with a second state of lateness of receiving the resource at the second time.

18. The method of claim 17, wherein a cross section between the first axis at the first time and the second axis at the second time comprises a weight indicating a predicted amount of the resource that will be received late from the first time to the second time.

19. The method of claim 18, wherein determining the condition associated with the resource based on the model comprises applying the weight associated with the predicted amount of the resource to the current amount of the resource.

20. The method of claim 19, wherein determining the condition associated with the resource based on the model further comprises applying a second weight to the second amount based on at least one of: an offboarding of the user from a digital platform, a characteristic of the user, or a most recent receiving of the resource.
